(19) United States
(12) Patent Application Publication
(10) Pub. No.: US 2010/0282989 A1
(43) Pub. Date: Nov. 11, 2010

(54) VALVE

(75) Inventor: Elias Hajjar, Bankstown (AU)

Correspondence Address: SUGHRUE MION, PLLC, 2100 PENNSYLVANIA AVENUE, N.W., SUITE 800, WASHINGTON, DC, 20037, US

(73) Assignee: MICROFLOW INTERNATIONAL PTY LIMITED, Darlinghurst, New South Wales (AU)

(21) Appl. No.: 12/667,600

(22) PCT Filed: Jul. 8, 2008
(86) PCT No.: PCT/AU08/01001

§ 371 Date: Jul. 27, 2010

(30) Foreign Application Priority Data
Jul. 11, 2007 (AU) 2007-903777

(51) Int. Cl. F16K 31/02

(52) U.S. Cl. 251/129.15

(57) ABSTRACT

A valve device (1) including a fluid inlet (4), a fluid outlet (5), a valve seat (6), a valve member (3) movable relative to a valve seat (6), a control chamber (12), the volume of the chamber being variable depending on the position of said valve member (3), a fluid passageway (7) formed in said valve member (3), providing fluid communication between said fluid inlet (4) and said control chamber (12), a flow control element (8) provided in said fluid passageway (7) such that only a small flow rate is permitted to flow in said fluid passageway, a relief port (9) providing fluid communication between said control chamber (12) and either said fluid outlet (5) or an external outlet, and, a control means to control the position of said valve member (3), either directly or indirectly, and to thereby control the operating of said valve device (1), the control means including a plunger (2) selectively actuated by a solenoid (10).

### BACKGROUND OF THE INVENTION

The present invention relates to a valve device, and in particular to a hydraulically assisted valve device. The valve device of the present invention provides significant advantages over prior art valve devices in that considerably lower flow rates of fluid than that of prior art devices are enabled to operate the valve. This, in a solenoid operated valve, results in significantly lower operational power requirements.

### DESCRIPTION OF THE PRIOR ART

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

FIGS. 1 and 2 show the most common arrangements used in hydraulically assisted valves.

In all of the three instances, lowering the actuation power depends on the lowest achievable by pass/pilot flow rate and the smallest reliable by pass passages (in particular the relief passageway).

In general the industry conventionally accept that the inlet of the by pass/pilot passageways is a hole of about 1 mm diameter and the outlet (particularly the relief port) is a hole of about 2.0 mm diameter. This under typical operating conditions and for the vast majority of applications corresponds to about 300 to 1000 ml/min of by pass flow rates.

FIG. 1 illustrates an arrangement of hydraulically assisted valves which the industry continues to adopt for controlling flow rates lower that about 50 L/min. (the industry in general adopts this arrangement because the by pass flow rate requires slightly less axial plunger movement than that needed to establish the required main flow.

Note the axial movement of the plunger is equal to the axial movement of the valve member plus the axial gap needed to open the relief passage way. That is in such instance lowering the actuation power by adopting the arrangement of FIG. 2 is relatively too insignificant to justify the additional complications it represents.

The actuation power of this arrangement largely depends on the relief port cross-section and displacement of the main valve member.

FIG. 2 illustrates an arrangement of a hydraulically assisted valve which the industry adopts for controlling flow rates larger than 50 L/min.

The additional power that would be associated with the relatively large displacement needed to control large flow rates becomes significant enough to justify the use of this arrangement.

Unlike the arrangement of FIG. 1 the displacement of the main valve member has no effect on the actuation power. That is, the actuation power in this case depends on the relief port cross section and the smaller displacement of the relief vale (not the main valve member) member displacement.

The Applicant has previously invented a valve device which utilises a flow control element, described in the Applicant's earlier International Patent Application No. Pct/AU96/00263, the entire disclosures of which should be considered to be incorporated herein, by this reference thereto.

### SUMMARY OF THE INVENTION

The present invention seeks to overcome some of the disadvantages of the prior art.

The present invention seeks to provide an improved valve device in which the flow rates required to initiate operation of the valve are significantly reduced.

The present invention also seeks to provide an improved valve device in which the power required to move the plunger in a solenoid actuated valve is significantly reduced.

In one broad form, the present invention provides a valve device including a fluid inlet; a fluid outlet; a valve seat defining an aperture through which fluid may flow from said inlet to said outlet; a valve member at least partly formed of flexible material, such as but not limited to a diaphragm or the like, movable relative to a valve seat, between an open position in which fluid may flow from said in let to said outlet, and a closed position in which fluid flow is prevented; a control chamber, at least a portion of the wall of which is formed by said valve member, such that the volume of the chamber is variable depending on the position of said valve member; a fluid passageway formed in said valve member, providing fluid communication between said fluid inlet and said control chamber; a flow control element provided in said fluid passageway such that only a small flow rate is permitted to flow in said fluid passageway; a relief port providing fluid communication between said control chamber and either said fluid outlet or an external outlet; and, a control means, to control the position of said valve member, either directly or indirectly, and to thereby control the operating of said valve device, the control means including a plunger selectively actuated by a solenoid.

Preferably, said relief port is formed as an orifice provided in said valve member to selectively enable fluid communication between said control chamber and said fluid outlet, and wherein said plunger acts directly on said valve member in a manner such that, in a closed position, said plunger abuts against said valve member and blocks said relief port, and, in an open position, said plunger is withdrawn from said valve member to permit flow of fluid through said relief port.

Also preferably the device of the present invention is embodied in which said relief port is operatively connected to the fluid inlet of a further valve device cascaded thereto, such that said further device operates as a pilot valve for a main valve device.

### BRIEF DESCRIPTION OF THE DRAWINGS

The present invention will become more fully understood from the following detailed description of preferred but non limiting embodiments thereof, described in connection with the accompanying drawings, in which:

FIG. 1 shows a prior art valve device;

FIG. 2 shows prior art cascaded valve devices;

FIG. 3 shows a preferred embodiment of a valve device according to one aspect of the present invention;

FIG. 4 shows a preferred embodiment of a valve assembly, including a main valve device and a pilot valve device, according to another aspect of the present invention;

FIG. 5 shows a preferred embodiment of a valve assembly, including a plurality of valve devices, according to yet another aspect of the present invention; and

FIG. 6 shows an alternative preferred arrangement of the valve device of the present invention.

### DETAILED DESCRIPTION OF THE PREFERRED EMBODIMENTS

Throughout the drawings, like numerals will be used to identify like features, except where expressly otherwise indicated.

It should be initially recognised that the present invention is related to the Applicant's earlier invention, which is the subject of International Patent Application No. PCT/AU96/00263. The entire disclosures of this earlier patent application should be considered to be incorporated herein by this reference thereto.

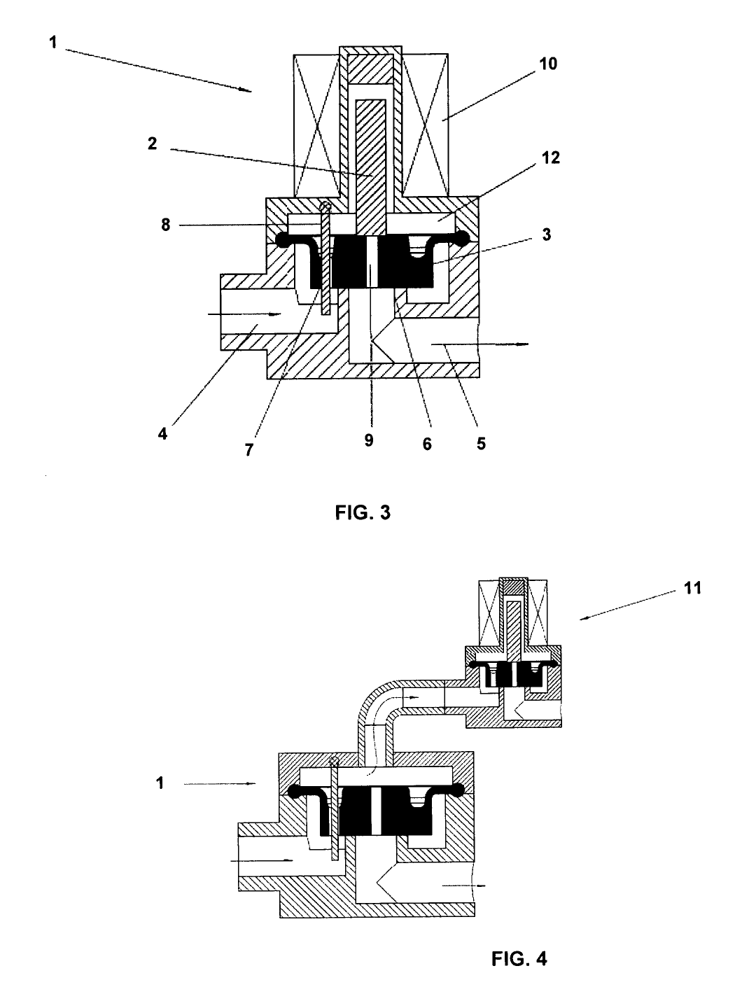

FIG. 3 shows a valve device, generally designated by the numeral 1, in which the position of the valve member is controlled directly by the actuation of a solenoid actuated plunger. FIG. 3 shows the valve in closed position, in which the plunger 2 abuts against the valve member 3, such that the valve member 3 rests against the valve seat 6, whereby fluid is effectively prevented from flowing from the fluid inlet 4 to the fluid outlet 5.

As shown, the valve member is at least partly formed of a flexible material, and effectively forms one wall of a control chamber 12. The valve member 3 is preferably constructed in the form of a diaphragm, with a more rigid central portion and a more flexible peripheral portion which abuts against the walls of the control chamber 12 in a sealing manner. Therefore some movement of the diaphragm or valve member 3 is therefore permitted, allowing it to move to and from the valve seat 6, depending on the position of the plunger 2.

The valve member includes a fluid passageway 7, which itself has a flow control element 8 therein (which will be described later), and, a relief port 9.

The fluid passageway 7 provides fluid communication between the inlet port 4 and the control chamber 12. The relief port 9 provides fluid communication between the control chamber 12 and the outlet port 5.

The flow control element 8 is provide in the fluid passageway 7, to restrict the flow of fluid through the fluid passageway such that only an extremely small amount of fluid can therefore flow through the passageway 7. The flow control element furthermore effectively substantially prevents the ingress of dirt or like particles from entering the fluid passageway 7, and if any does, the relatively movement of the flow control element 8 within the passageway 7 of the valve member 3, acts to remove or expel such particles from within the passageway 7. This self cleaning operation has significant advantages over the prior art devices which are prone to blockage. The flow control element 8 may be retained in its optimal position by being attached to the wall of the control chamber 12 as shown in FIG. 3, but those skilled in the art will appreciate that it may be otherwise retained in position by, for example, being attached to the valve member 3. The flow control element may be embodied as a rigid rod, formed with metal or like material, and should be selected such that its cross-sectional area is slightly smaller than the cross-sectional area of the fluid passageway 7 into which it is received, such that a very small flow of fluid therearound is permitted to flow. This therefore provides the fluid flow restrictive properties of the present invention. In manufacture of the fluid passageway, an appropriately sized orifice can be readily formed, and then, in use, the amount of fluid flowing through the passageway 7 can be limited by installing the flow control element 8.

Operation of the valve device 1 will be hereinafter described.

It should be initially understood that in the closed position of the valve device, as shown in FIG. 3, the fluid pressure in the control chamber 12 is substantially identical to the fluid pressure in the inlet port 4, due to fluid communication via the fluid passageway 7. Also, it should be understood that the fluid pressure in the outlet port 5 is less than the fluid pressure in inlet port 4.

To open the valve device 1, to permit fluid flow from the inlet 4 to the outlet 5, the solenoid 10 is activated, such that the plunger 2 moves from the position shown in FIG. 3 to a position spaced away from the valve member 3, and such that the relief port 9 is opened. As a result, some fluid flows from the higher pressure control chamber 12 to the lower pressure outlet port 5 via the relief valve 9. When the pressure in the outlet port and the control chamber is substantially equalised, the valve member 3 easily moves away from the valve seat 6, permitting the flow of fluid from the inlet 4 to the outlet 5.

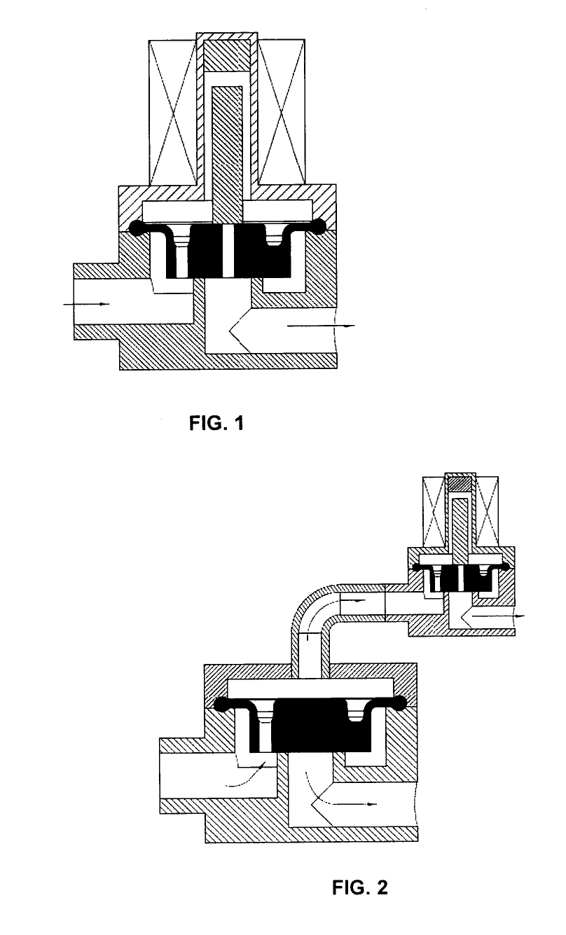

The uniqueness of the present invention resides in the use of a flow control element 8 within the fluid passageway 7, meaning that only an extremely small amount of fluid flow occurs, and in particular, this is significantly smaller amount of flow compared with the prior art devices, as described herein in relation to FIGS. 1 and 2. This also enables a significantly smaller relief port orifice to be utilised to initiate the flow of fluid when the plunger 2 is moved away from the valve member 3. The consequential result of the small flow rates is that only relatively small pressure differentials are required to cause operation of the valve 1, and therefore, only relatively small movement and forces are required of the plunger 2, meaning that only relatively low power is required to actuate the solenoid 10. This is a significant distinguishing difference from the prior art.

FIG. 4 shows an alternative valve device arrangement to that shown in FIG. 3. In the embodiment of FIG. 4, the relief port is not provided in the valve member, but rather, the relief port is embodied as another valve device, effectively cascaded thereto. The cascading valve device 11, which includes the solenoid and plunger arrangement effectively operates as a pilot device to control the operation of the main valve device 1, allowing a smaller power to be required to operate the valve than if just the valve device 1 shown in FIG. 3 is used.

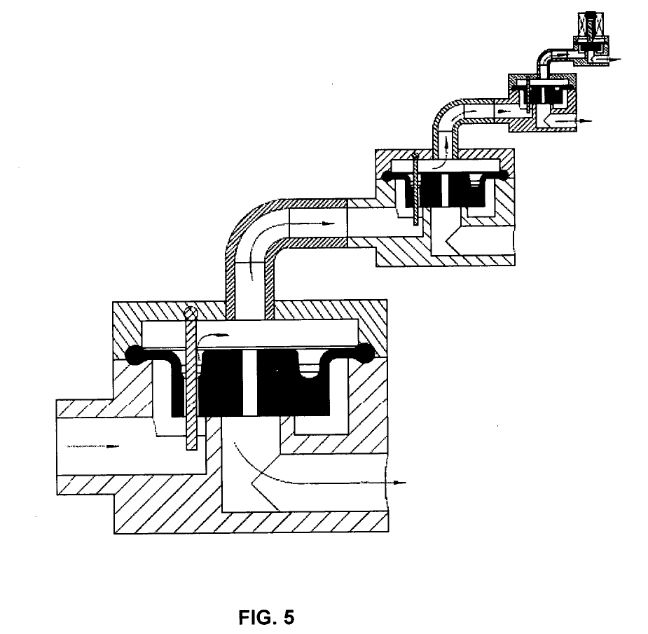

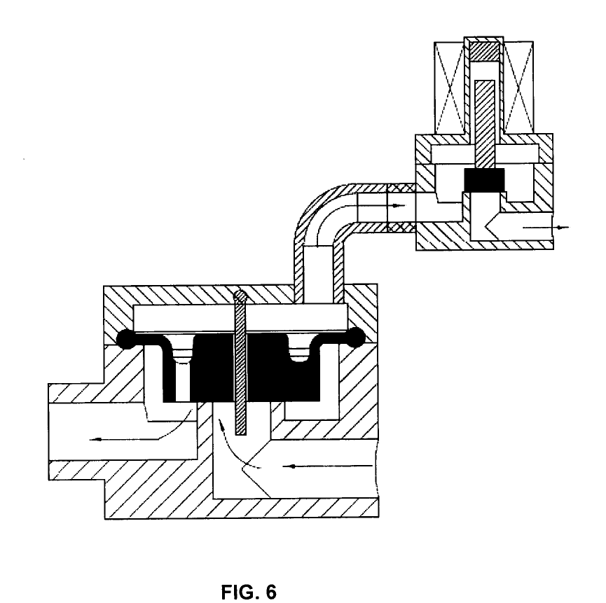

FIG. 5 shows yet another alternative valve device arrangement to that shown in FIG. 4, wherein a plurality of valve devices are cascaded together, to thereby reduce the power requirements significantly to control the operation of the valve.

The cascaded devices of FIGS. 4 and 5 operate as follows. When the solenoid 10 of the final valve in the cascaded series of valve is operated, the plunger 2 moves away from the relief port 9, permitting fluid to flow from the inlet 4 to the outlet 5 of the final valve. This then causes operation of each previous valve in the cascaded series, to cause operation of the cascaded valve device in entirety. It will be appreciated that the more valve devices that are cascaded together results in additional reduction in power requirements to operate the overall device.

The valve member 3 is, as herein before described, preferably formed at least partially of a flexible material. As illustrated in the drawings, the central portion of the valve member 3 is preferably formed of a more rigid material. Hard rubber, operationally reinforced, perhaps with metal, is a suitable material. This allows for easy formation of the fluid passageway therein, which are not prone to the deterioration or tearing of the prior art orifices of the diaphragm components. The outer periphery of the valve device is preferably of a more flexible material to allow the member to move to and from the valve seat 6 whilst providing good fluid sealing properties therearound. A rubberised material is suitable.

Hydraulically assisted valves, irrespective of the adoptive arrangement or the specific design, can be incorporated with the arrangement of the present invention to provide them with low and consistent flow rates which in turn enable:
More control over their time response
More reliable operating characteristics such as flow regulations with less actuating forces and or power with improved or without compromising the operating reliability associated with dirt and deposits present in the fluid.

FIGS. 3, 4 and 5 are examples of how the present invention may be incorporated in both existing and newly designed hydraulically actuated valves.

Note the main flow of these valves could be the pilot flow of a larger hydraulically actuated valve upstream. Also note in FIG. 2 reducing the orifice size and the plunger stroke of the pilot valve without the flow control element arrangement are respectively limited to:
A size that does not get clogged by the dirt and deposit present in the fluid flowing through it; and
To the extent to which the rate of the pilot flow can be reduced reliably and consistently.

It is conventionally and widely accepted that, for the vast majority of industrial fluid control applications (including water distribution systems), the bypass passageways upstream the pilot valve should not be less than about 1 mm diameter holes with flow capacity of about 800 ml/min. Also, the orifice of the pilot valve itself is not less than about 2 mm diameter holes. It is well known that these limitations are necessary for ensuring adequate valve reliability. But with the inherent features of the flow control element arrangement of the present invention which include:
The relative automatic movement;
The prevention of relatively large particles ingress and thus shielding down stream openings;
Allowing these particles to get washed away with the main flow; and
Providing the means of choosing the degree of flow restriction.

In the first instance the values of these limiting factors are reduced by about a factor of ten (10) depending on the application.

That is the examples illustrated by FIGS. 3, 4 & 5 (if needed) can now have:
Bypass flow rates of less than 50 ml/min
Relief port orifices (2r) of less than 0.2 mm diameter; and
A relief valve member movements (D) of less than 0.1 mm.
   But, for the immediate future and most practical current applications, there would be no need to go below relief port orifices (2r) of less than 0.5 mm diameter and thus displacement (D) of about 0.25 mm.

The actuation power requirement of any hydraulically actuated valve can be calculated using the following equation,

P=p×A×D/t

### Where;

P=actuation power requirement (watt) (excluding the power losses of the system)
p=pressure drop across the valves (Mpa)
A=cross-sectional area of the relief orifice (mm²). In most instances this orifice is a hole and therefore, A=πr²
r=the radius of the relief port orifice (mm)
D=displacement of the relief valve member (mm). Note: For most practical applications, D≦r. But, for now, assume it is equal to r.
t=actuation duration (sec)

The following page gives an idea as to what extent the actuation power of this type of valves can be reduced with the use of the present invention. The calculation is done using the above equation and assumptions.

$$\begin{matrix}{P}_{c} = \frac{{PA}_{c} {D}_{c}}{t} \\ = the actuation power of the conventional valve\end{matrix}$$

$$\begin{matrix}{P}_{Mf} = \frac{{PA}_{Mf} {D}_{Mf}}{t} \\ = the actuation power of the value of the present invention\end{matrix}$$

$$\begin{matrix}\frac{{P}_{c}}{{P}_{Mf}} = \frac{{PA}_{c} {D}_{c} / t}{{PA}_{Mf} {D}_{Mf} / t} \\ = \frac{{A}_{c} {D}_{c}}{{A}_{Mf} {D}_{Mf}} \\ = \frac{π {r}_{c}^{2} {D}_{c}}{π {r}_{Mf}^{2} {D}_{Mf}}\end{matrix}$$

$$for D \approx r then$$

$$\frac{{P}_{c}}{{P}_{Mf}} \approx \frac{{r}_{c}^{2} {r}_{c}}{{r}_{Mf}^{2} {r}_{Mf}} \approx \frac{{r}_{c}^{3}}{{r}_{Mf}^{3}}$$

$$if {r}_{c} = 1 mm and$$

$${r}_{Mf} = 0.1 mm then$$

$$\frac{{P}_{c}}{{P}_{Mf}} = \frac{{1}^{3}}{{0.1}^{3}} = 1000$$

The present invention has been herein described with reference to particular preferred embodiments. It will however be readily understood to persons skilled in the art that numerous variations and modifications may be made to these preferred embodiments. All such variations and modifications should be considered to fall within the spirit and scope of the invention as broadly hereinbefore described.

1. A valve device including:
a fluid inlet;
a fluid outlet;
a valve seat defining an aperture through which fluid may flow from said inlet to said outlet;
a valve member at least partly formed of flexible material movable relative to a valve seat, between an open position in which fluid may flow from said inlet to said outlet, and a closed position in which fluid flow is prevented;
a control chamber, at least a portion of the wall of which is formed by said valve member, such that the volume of the chamber is variable depending on the position of said valve member;
a fluid passageway formed in said valve member, providing fluid communication between said fluid inlet and said control chamber;
a flow control element provided in said fluid passageway such that only a small flow rate is permitted to flow in said fluid passageway;
a relief port providing fluid communication between said control chamber and either said fluid outlet or an external outlet; and
a control means, for controlling the position of said valve member, either directly or indirectly, to thereby control the operating of said valve device, the control means including a plunger selectively actuated by a solenoid.

2. A valve device as claimed in claim 1, wherein said relief port is formed as an orifice provided in said valve member to selectively enable fluid communication between said control chamber and said fluid outlet, and wherein said plunger acts directly on said valve member in a manner such that,
in a closed position, said plunger abuts against said valve member and blocks said relief port, and,
in an open position, said plunger is withdrawn from said valve member to permit flow of fluid through said relief port.

3. A valve device as claimed in claim 1, wherein said relief port is operatively connected to the fluid inlet of a further valve device cascaded thereto, such that said further device operates as a pilot valve for a main valve device.

4-6. (canceled)

7. A valve device as claimed in claim 1, wherein said valve member is a diaphragm.
